(19) United States
(12) Patent Application Publication
(10) Pub. No.: US 2026/0326883 A1
(43) Pub. Date: Oct. 22, 2026

(54) ENERGY ABSORBING FLOOR STRUCTURE FOR SINGLE-DECK BLENDED WING BODY AIRCRAFT

(71) Applicant: Spirit AeroSystems, Inc., Wichita, KS (US)

(72) Inventor: Randall Ray West, Wichita, KS (US)

(21) Appl. No.: 19/182,765

(22) Filed: Apr. 18, 2025

(51) Int. Cl. B64C 1/18; B64C 1/00; B64C 39/10

(52) U.S. Cl. CPC B64C 1/18; B64C 2001/0054; B64C 39/10; B64C 2039/105

(57) ABSTRACT

An energy absorbing flooring system for a single-deck blended wing body (BWB) aircraft employs a plurality of energy absorbing members between the skin panels and the floor deck to absorb impact energy imparted on the single-deck BWB aircraft and thereby reduce impact energy conveyed to the main lobe. The energy absorbing flooring system fits in a lower lobe less than 24 inches tall. The energy absorbing flooring system may include energy absorbing stanchions interconnected between stub frames and floor beams in the lower lobe. The energy absorbing flooring system may include compressible energy absorbing members, each with a casing surrounding a core and restraints affixing the casing to the core to define discrete crush zones.

### FIELD OF INVENTION

The present disclosure relates to a flooring system for use with an aircraft. More particularly, the present disclosure relates to a flooring system that includes a plurality of compact energy absorbing members that are designed to distribute a force across the flooring system during the occurrence of a high impact event.

### BACKGROUND

Sustainability is a priority in the aviation industry. The focus on sustainable aviation has driven the industry to investigate fuel-efficient alternatives to tube-and-wing (TnW) aircraft configurations, such as blended wing body (BWB) aircraft. Early BWB aircraft concepts had two-deck configurations similar to TnW aircraft. That is, the aircraft included an upper deck for the passenger cabin and a lower deck for cargo and landing gear storage.

A shift away from large, high-capacity aircraft (e.g., Boeing 747, Airbus A380) has resulted in newer BWB configurations with comparable seating capacities to today's single-aisle TnW aircraft (e.g., Boeing 737, Airbus A320) and twin-aisle TnW aircraft (e.g., Boeing 767, Boeing 787, Airbus A330, Airbus A350). The newer BWB configurations effectively eliminates the lower deck of earlier BWB concepts. The elimination of the lower deck, sometimes referred to as lower lobe, means that newer BWB configurations cannot rely on the cargo compartment volume of the lower deck to form an energy absorbing zone for absorbing energy from impacts.

Newer BWB configurations include only a single “deck” above the bottom hull of the aircraft. The lower lobe between the floor deck and the bottom hull of the aircraft is very short. At most the height of the lower lobe permits it be used as a chase for flexible utilities. The remainder of the minimal height is occupied by the structural components of the bottom hull and floor. The short lower lobe provides much less energy absorption potential under impact conditions than the conventional lower cargo compartment in a two-deck aircraft.

### SUMMARY OF THE INVENTION

In one aspect, an energy absorbing flooring system for a single-deck blended wing-body (BWB) aircraft comprises a skin assembly comprising skin panels forming an aerodynamic surface along a bottom side of the BWB aircraft and a plurality of stub frames joined to the skin panels. A plurality of floor beams are spaced apart above the stub frames by a height of less than 24 inches. Floor decking is supported on the floor beams. A plurality of energy absorbing stanchions are provided. Each energy absorbing stanchion comprises a lower end portion affixed to one of the stub frames and an upper end portion affixed to one of the floor beams. The energy absorbing stanchions are configured to absorb energy from an impact on the BWB aircraft by deforming or structurally failing.

In another aspect, an energy absorbing flooring system for a single-deck blended wing-body (BWB) aircraft comprises skin panels forming an aerodynamic surface along a bottom side of the BWB aircraft. A plurality of compressible energy absorbing members are joined to skin panels and configured for supporting floor decking in the single-deck BWB aircraft. Each compressible energy absorbing member comprises a core and a casing surrounding the core. Each compressible energy absorbing member further comprises at least one restraint affixing the casing to the core to define a plurality of crush zones along which the compressible energy absorbing member is configured to collapse to absorb impact energy.

In another aspect, a single-deck blended wing body (BWB) aircraft comprises a center body defining an interior volume including a main lobe and a lower lobe. Blended wings extend laterally outward from the center body. An energy absorbing flooring system includes a floor deck separating the main lobe from the lower lobe. A skin panel assembly includes skin panels defining a bottom aerodynamic surface of the single-deck BWB aircraft. A plurality of energy absorbing members are positioned between the skin panels and the floor deck. The energy absorbing members are configured to absorb impact energy imparted on the single-deck BWB aircraft to reduce impact energy conveyed to the main lobe. The lower lobe has a height extending from the skin panels to the floor deck. The height of the lower lobe is less than 24 inches.

Other aspects and features will be apparent hereinafter.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale, and the proportion of certain elements may be exaggerated for the purpose of illustration.

FIG. 1A is a top view of an exemplary blended wing body aircraft,

FIG. 1B is a bottom view of the blended wing body aircraft of FIG. 1A,

FIG. 1C is a front view of the blended wing body aircraft of FIG. 1A,

FIG. 1D is a left-hand side view of the blended wing body aircraft of FIG. 1A,

FIG. 1E is a rear view of the blended wing body aircraft of FIG. 1A,

FIG. 2 is a sectional front view of part of the blended wing body aircraft of FIG. 1A,

FIG. 3 is a perspective view of an energy absorbing flooring system according to one embodiment,

FIG. 4 is a perspective view of the energy absorbing flooring system of FIG. 3,

FIG. 5 is a side view of an energy absorbing member of the energy absorbing flooring system of FIG. 3,

FIG. 6 is a side view of the energy absorbing member of the energy absorbing flooring system of FIG. 5 that is deformed from a compressive force,

FIG. 7 is a perspective view of a seating system of the energy absorbing flooring system of FIG. 3,

FIG. 8 is a side view of a compressible absorbing member, and

FIG. 9 is a side view of the compressible absorbing member of FIG. 8 that has been deformed by a compressive force.

### DETAILED DESCRIPTION

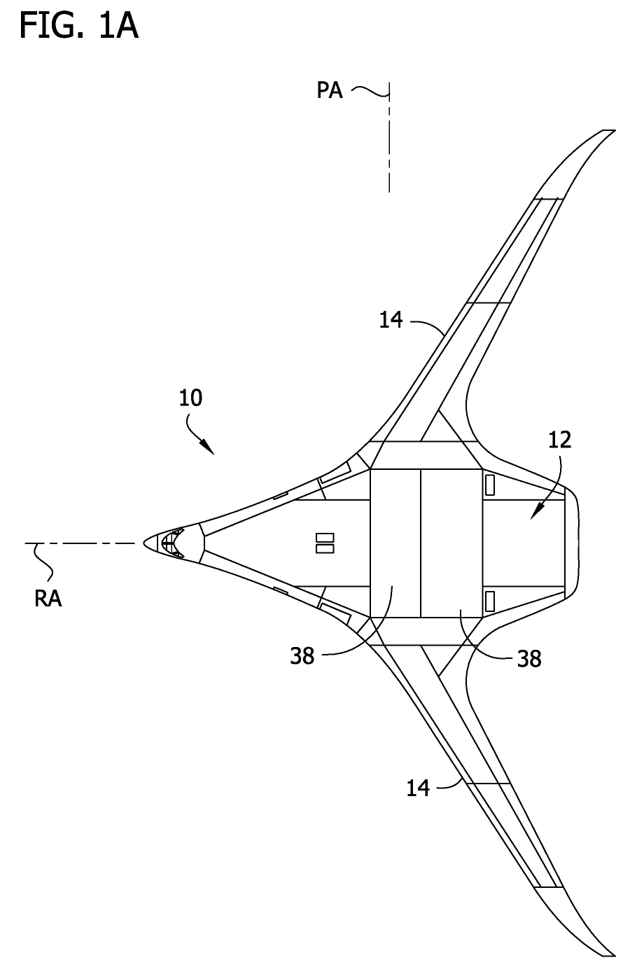

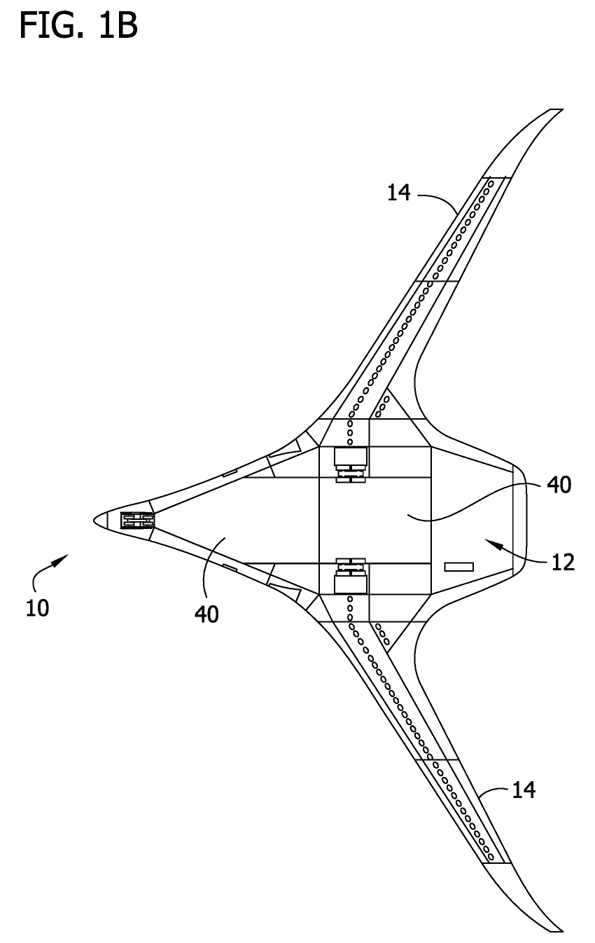

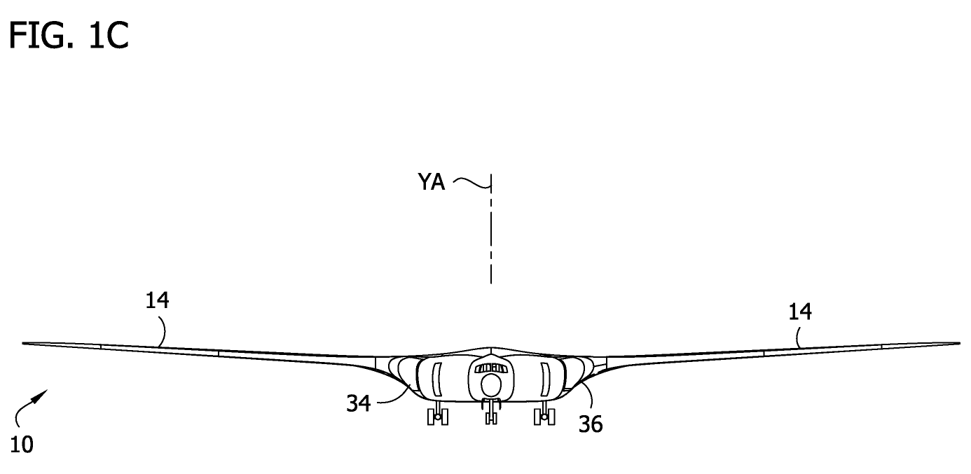

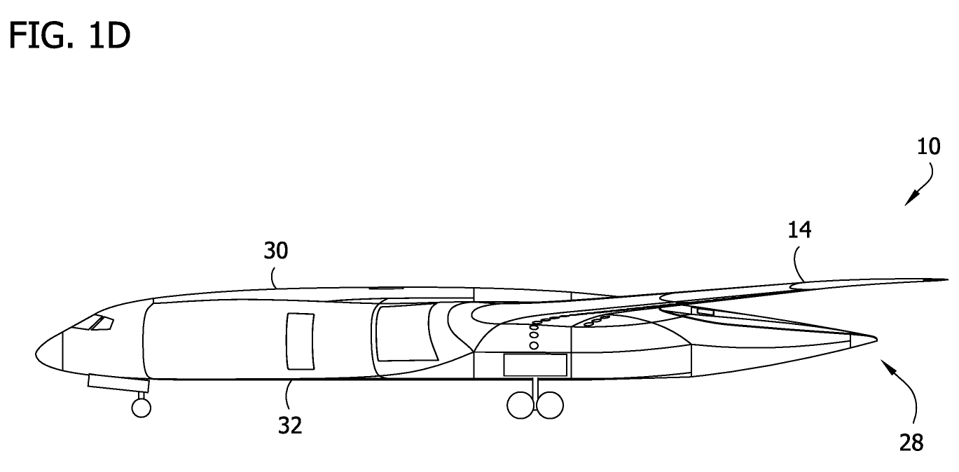

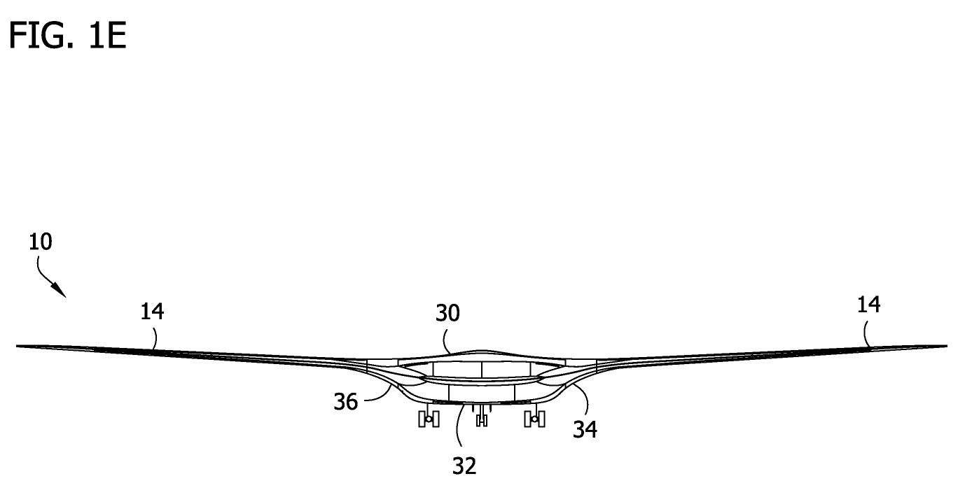

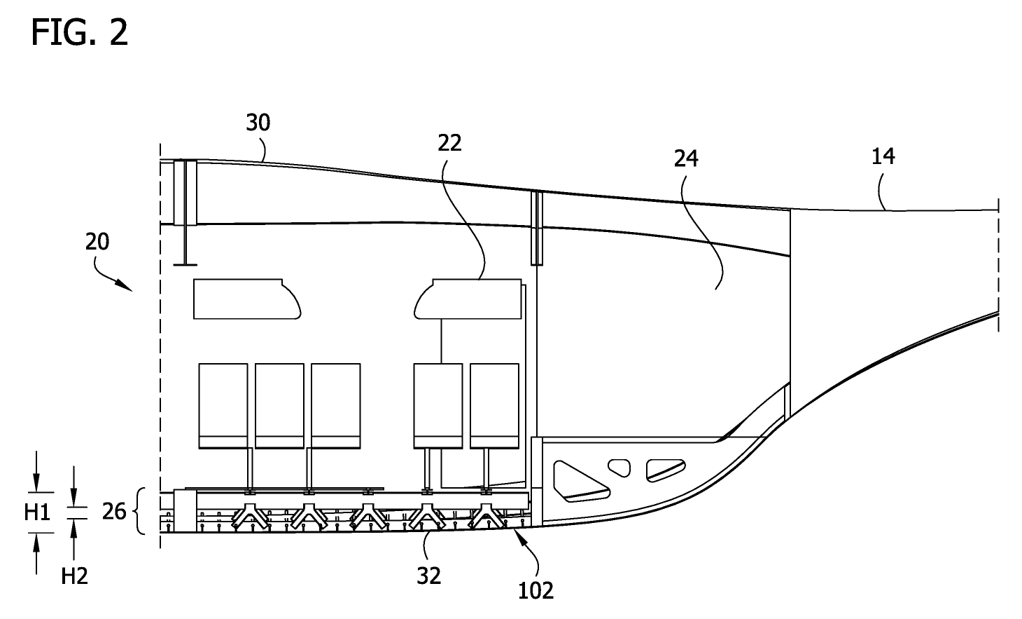

FIGS. 1A–1E illustrate various external views of one embodiment of a blended wing body (BWB) aircraft 10. FIG. 2 illustrates a sectional front view of part of the BWB aircraft 10 equipped with an exemplary energy absorbing flooring system 102. The BWB aircraft 10 has a longitudinal roll axis RA, a lateral pitch axis PA, and a vertical yaw axis YA. The BWB aircraft includes a center body 12 and blended wings 14 positioned laterally outward on either side of the center body 12. The center body 12 defines an interior volume 20 including a passenger cabin 22, cargo holds 24 that are positioned laterally outward on each side of the passenger cabin 22, and a lower lobe 26 positioned below the passenger cabin 22. The center body 12 has a lower hull 28 and an upper surface 30. The lower hull 28 has a bottom side 32, a first sidewall 34, and a second sidewall 36. The sidewalls 34, 36 are disposed between the bottom side 30 and top side 32. The bottom and top sides 30, 32 are formed by a plurality of upper skin panels 38 and lower skin panels 40, respectively, and define aerodynamic surfaces of the BWB aircraft.

The illustrated BWB aircraft 10 is a single-deck BWB aircraft 10. This means that there is only one main floor level of the aircraft on which to hold passengers and cargo. In contrast, conventional TnW aircraft have two decks stacked one atop the other, and both of the decks are capable of holding passengers and/or cargo. The lower lobe 26 below the main floor of the single-deck BWB aircraft 10 mainly accommodates the structural framework necessary for the lower skins 40 and main deck flooring. The lower lobe 26 may also be used as a chase for small utility lines like cables and piping. The lower lobe 26 is very short in height in comparison with the lower deck of a conventional two-deck TnW aircraft. In some embodiments, the lower lobe 26 has a maximum height H1 (FIG. 2) of less than 24 inches. Thus, the lower lobe 26 is not suitable for passengers or use as a cargo hold.

In an emergency landing, the center body 12 of the BWB aircraft 10 may be subjected to energy from impact forces imparted on the center body as the BWB aircraft collides with the ground. The impact forces generally compress the center body 12 along the vertical yaw axis YA. The energy absorbing flooring system 102 is configured to absorb and distribute the energy experienced by the center body 12. It is configured to increase the survivability during emergency landings. The energy absorbing flooring system 102 may include one or more stages of energy absorption to absorb, distribute, and dissipate the energy experienced during the emergency landing. Each stage of energy absorption may be designed to have integrated “weaknesses” to absorb the impact and compressive forces through structural deformation and/or structural failure. Multiple stages of energy absorption may act in a cascading fashion and/or in unison to mitigate the forces experienced during emergency landings.

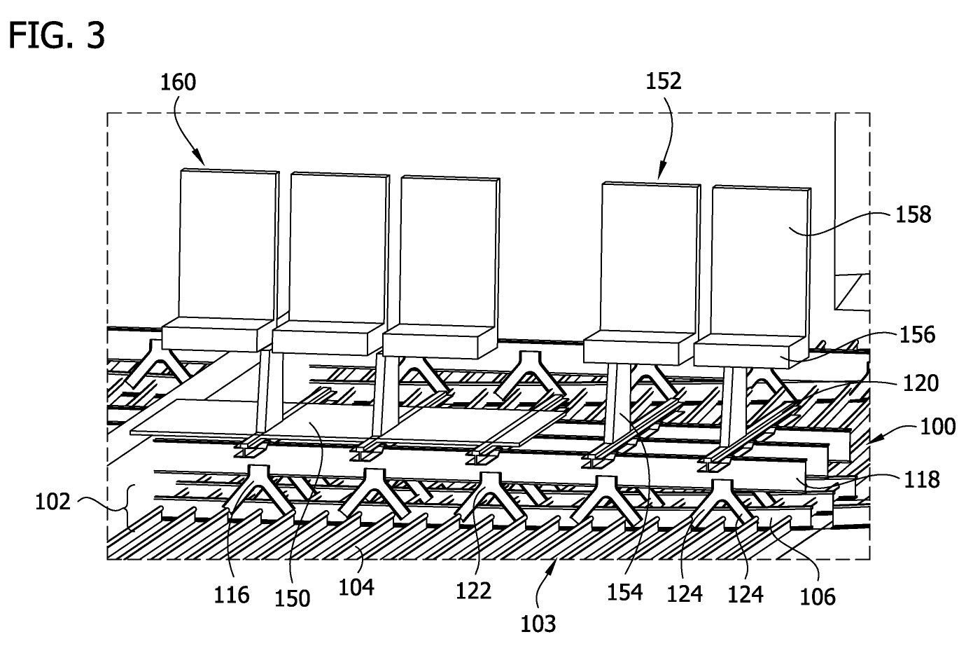

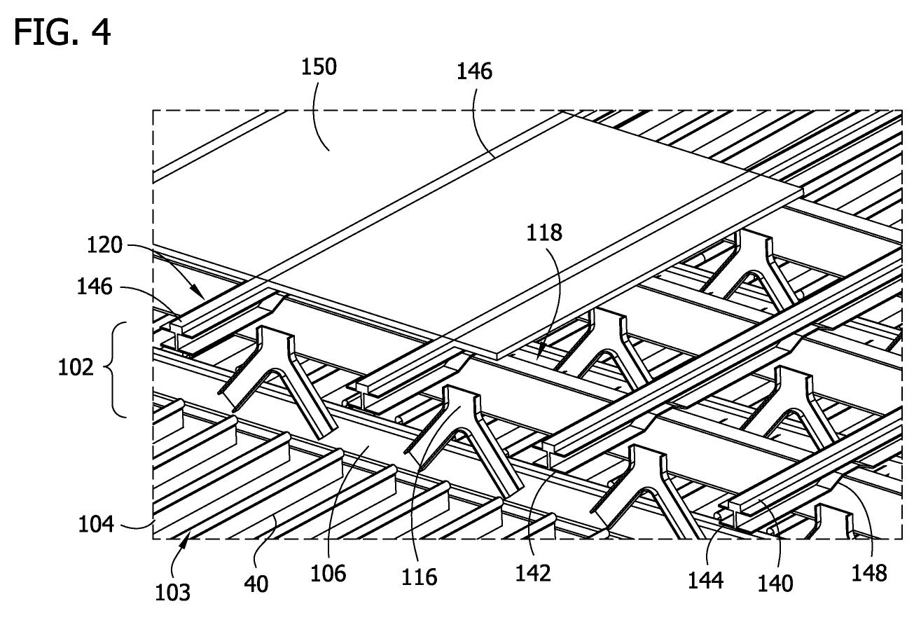

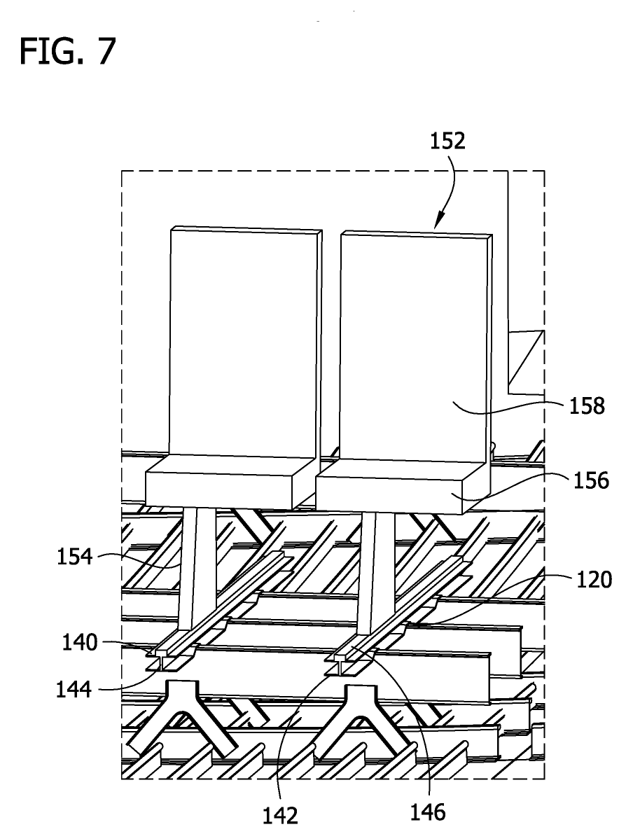

An exemplary embodiment of the energy absorbing flooring system 102 is shown in FIGS. 2–11. The energy absorbing flooring system 102 is disposed below the passenger cabin 22 in the lower lobe 26 of the BWB aircraft 10. The energy absorbing flooring system 102 includes a skin assembly 103 comprising the lower skin panels 40, a plurality of ribs 104 joined to the lower skin panels 40, and a plurality of stub frames 106 that intersect the plurality of ribs 104 and are likewise joined to the skin panels 40. The ribs 104 extend longitudinally along the inner surface of the lower skin panels 40. The stub frames 106 extend spanwise (generally parallel to the lateral pitch axis PA) along the inner surface of the lower skin panels 40. Each rib 104 is spaced laterally apart from adjacent ribs 104 across a width of the lower skin panels 40. The stub frames 106 are spaced apart and arranged substantially parallel to one another and substantially perpendicular to the ribs 104, such that the grid of reinforcement along the skin panels 40 resembles a rectangular lattice or a square lattice. In alternative embodiments, the stub frames 106 may not be substantially parallel to one another and may not be substantially perpendicular to the ribs 104. In further alternative embodiments, the grid of reinforcement may resemble an oblique lattice or a hexagonal lattice.

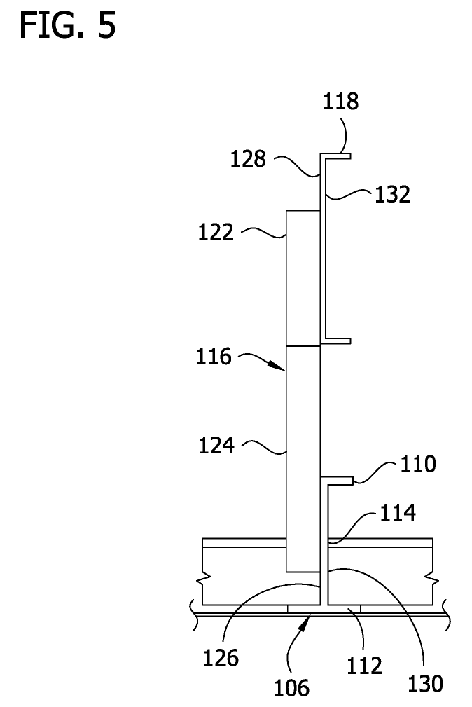

In the illustrated embodiment depicted in FIG. 5, the stub frames 106 are beams that have an upper flange 110, a lower flange 112, and a web 114 disposed between the upper and lower flanges 110, 112. The upper flange 110 extends laterally outward from one side of the web 114 such that the upper flange resembles an L-beam. The lower flange 112 extends laterally outward from both sides of the web 114 such that the lower flange 112 resembles a T-beam. In alternative embodiments, the stub frames 106 may be comprised of other suitable flanged beams such as I-beams, H-beams, W-beams, L-beams, T-beams, or a combination thereof. In alternative embodiments, the stub frames 106 may be comprised of planks that do not include flanges.

Referring collectively to FIGS. 2–11, the energy absorbing flooring system 102 further includes a plurality of energy absorbing stanchions 116 (each, broadly, an energy absorbing member) that are affixed to the stub frames 106 and the floor beams 118. In the illustrated embodiment, the floor beams 118 are arranged substantially parallel to the stub frames 106. Furthermore, the floor beams 118 are spaced planarly above the stub frames 106. In other words, each floor beam 118 is directly above one of the stub frames 106. The floor beams 118 are arranged substantially parallel to one another and are substantially perpendicular to the ribs 104. The floor beams 118 are configured to extend spanwise along a width of the lower lobe 26.

In the illustrated embodiment, a plurality of seat tracks 120 are affixed to a portion of the upper surface of the floor beams 118. The seat tracks 120 are arranged substantially perpendicular to the floor beams 118 such that each seat track 120 extends longitudinally across the upper surface of multiple floor beams 118.

Each energy absorbing stanchion 116 comprises a lower end portion affixed (e.g., by fasteners) to one of the stub frames 106 and an upper end portion affixed (e.g., by fasteners) to the floor beam 118 located overhead. In one embodiment, during normal use, the energy absorbing stanchions 116 are non-load bearing components. That is, the energy absorbing stanchions 116 do not transfer load between the floor beams 118 and the stub frames 106 during normal use of the aircraft 10. However, in the event of a serious impact, the stanchions 116 can absorb substantial energy from the compressive impact load. Hence, the energy absorbing stanchions 116 are broadly configured to absorb energy from an impact on the BWB aircraft 10 by deforming or structurally failing. In an alternative embodiment, during normal use, the energy absorbing stanchions 116 are load bearing such that the stanchions transfer a portion of the weight of the flooring onto the stub frames 106.

In the illustrated embodiment, each energy absorbing stanchion 116 includes an upper member 122 that is oriented substantially vertical, and two lower members 124 that extend obliquely downward from the upper member 122, such that each energy absorbing stanchion is shaped as an inverted “Y.” In alternative embodiments, the energy absorbing stanchions may be other than Y-shaped. For example, it is contemplated that each energy absorbing stanchion (or each of a subset of the energy absorbing stanchions) can be a column or plank. In further alternative embodiments, the energy absorbing stanchions may have two or more upper members that extend obliquely upward. For example, each energy absorbing stanchion may be configured to have upper members extending obliquely upward and two lower members extending obliquely downward whereby each energy absorbing stanchion is substantially “X” shaped.

In the illustrated embodiment, each member 122, 124 has the same C-shaped cross sectional shape. In other embodiments, the members could have other cross-sectional shapes without departing from the scope of the disclosure.

In an exemplary embodiment, one or more of the stanchions 116 are made of metal and are configured to absorb energy through deformation. In certain embodiments, one or more of the stanchions are formed from composite material and are configured to absorb energy through structural failure.

In the illustrated embodiment, the lower members 124 of the energy absorbing stanchions 116 are affixed to a forward-facing surface 126 of each stub frame 106 and the upper members 122 of the energy absorbing stanchions 116 are affixed to a forward-facing surface 128 of each floor beam 118. In alternative embodiments, the lower members 124 may be affixed to an aft-facing surface 130 of the stub frames 106 and the upper members 122 may be affixed to an aft-facing surface 132 of the floor beams 118. In the illustrated embodiment, the lower members 124 are laterally spaced apart from one another along the length of each stub frame 106 and the upper members 122 are laterally spaced apart from one another along the length of each floor beam 118. In the illustrated embodiment, each individual upper member 122 is affixed to an individual floor beam 118 at a position that is spaced planarly below the intersection point of a corresponding seat track 120 with the floor beam 118. In alternate embodiments, the lower members of the energy absorbing stanchions may not be spaced apart such that adjacent energy absorbing stanchions abut one another. In further alternate embodiments, adjacent energy absorbing stanchions may be arranged in alternating orientations. For example, the energy absorbing stanchions may be distributed along the lengths of the stub frames and floor beams in alternating upside down “Y” and right side up “Y” orientations.

In the illustrated embodiment, each seat track 120 is a beam that includes an upper flange 140, a lower flange 142, a web 144 disposed between the upper flange 140 and the lower flange 142, and a locking channel 146 along the upper flange 140. Each seat track 120 further includes a plurality of receiving segments 148 along the bottom surface of seat track 120. The receiving segments 148 are comprised of portions of the lower flange 142 and web 144 that are configured to receive and fit around a portion of the top surface of a corresponding floor beam 118. In alternative embodiments, the seat tracks 120 may have a bottom planar surface such that there are no receiving segments 148.

The energy absorbing flooring system 102 may further include floor decking 150 supported on the floor beams 118. For example, the floor decking 150 may be supported directly on the seat tracks 120, which in turn are supported on the floor beams 118. The floor decking 150 comprises panels configured to fit between two adjacent seat tracks 120. The floor decking panels 150 may be supported by the upper flanges 140 of the adjacent seat tracks 120. In alternate embodiments, the floor decking 150 may be affixed to the adjacent seat tracks 120. In further alternate embodiments, the floor decking 150 may not be affixed to the seat tracks 120 such that the floor panels 150 are resistively retained between seat tracks 120.

Passenger seats 152 may be coupled to the seat tracks such that the passenger seats are likewise supported on the floor beams 118. In the illustrated embodiment, each passenger seat 152 includes a leg 154, a seat cushion 156, and a back cushion 158. The legs 154 may include a bottom lug that fits into the channels 146 of the seat tracks 120 and can be selectively locked in place at a plurality of spaced apart locations along the seat track 120.

As discussed above, the energy absorbing flooring system 102 may absorb the energy of an impact in multiple cascading stages to mitigate the forces experienced during emergency landings. In the illustrated embodiment, the first stage of energy absorption (“Stage One”) includes structurally deforming the energy absorbing stanchions 116. Initially, each energy absorbing stanchion is configured to absorb energy by crippling (cross-sectional deformation). In addition, the energy absorbing stanchions 116 will absorb impact energy by bending out of plane. Thus, the energy absorbing stanchions 116 are configured to act as energy absorbers and provide a collapsible volume between the bottom surface of the floor beams 118 and the upper surface of the stub frames 106. In certain embodiments, a height H2 between the bottom surface of the floor beams 118 and the upper surface of the stub frames 106 is less than 18 inches prior to any collapse. Thus it can be seen that the energy absorbing stanchions 116 are configured to add significant energy absorbing capacity to a small space that typically would have very little.

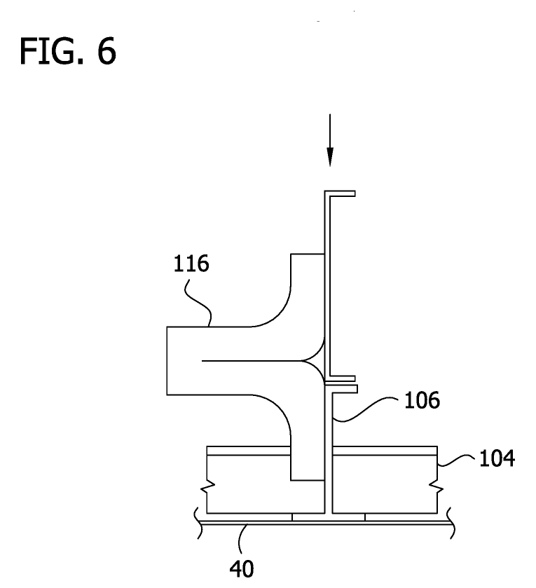

In FIG. 6, the energy acting on the energy absorbing flooring system 102 is depicted as an arrow. As depicted in here, the energy absorbing stanchions 116 are configured to absorb, distribute, and dissipate a portion of, or all of, the impact energy. The energy absorbing stanchions reduce the forces experienced by the passengers and contents of the center body 12 by deforming.

If the energy acted on the center body 12 during the emergency landing is greater than the energy the energy absorbing capacity of the stanchions 166, then the energy absorbing stanchions will deform and fully expend the energy absorbing capability of the energy absorbing stanchions 116. When the energy absorbing stanchions 116 are fully deformed, the energy absorbing stanchions 116 crumple and bend away from stub frames 106 and floor beams 118 such that the bottom surface of the floor beam 118 contacts the upper surface of the stub frames 106, as depicted in FIG. 6. The contact between the floor beams 118 and the stub frames 108 causes the second stage of energy absorption (“Stage Two”). Stage Two includes absorbing energy through structurally deforming and/or structurally failing the floor beams 118, the stub frames 106, or both. The floor beams 118 and stub frames 106 are configured to absorb and distribute additional impact energy when they are compressed together.

The energy absorbing stanchions 116, floor beams 118, and stub frames 106 may be comprised of metal or composite materials. Metallic material components are configured to absorb and dissipate energy through structural deformation. Composite material components are configured to absorb and dissipate energy through structural failure.

It is contemplated that the aircraft 10 can be equipped to facilitate additional stages of energy absorption. For example, it has been proposed to equip aircraft seats with energy absorbing capacity. See Astori, Paolo & Zanella, Mauro & Bernardini, Matteo (December 2020), Validation of Numerical Models of a Rotorcraft Crashworthy Seat and Subfloor, Aerospace 8(12):174. Such energy absorbing seats could be included in the aircraft 10. The energy absorbing seats would provide a third (or subsequent) stage of impact energy absorption that absorbs further impact energy once the energy absorbing capacities of Stage One and Stage Two have been exceeded.

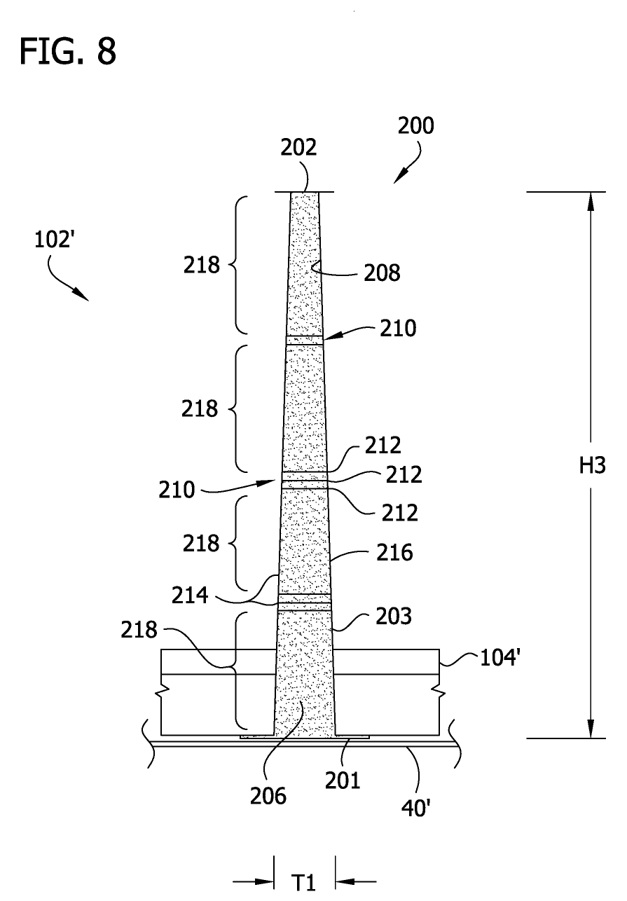

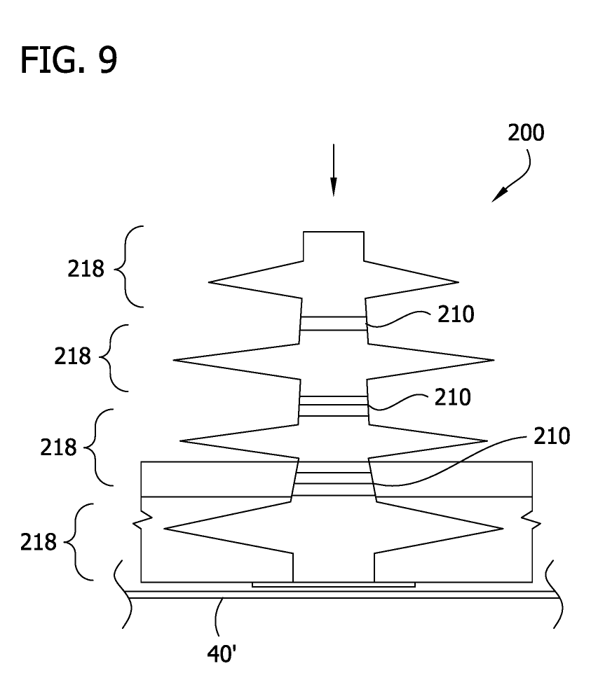

Referring to FIGS. 8 and 9, another exemplary embodiment of an energy absorbing flooring system in the scope of the present disclosure is generally indicated at reference number 102'. The energy absorbing flooring system 102' is similar to the energy absorbing flooring system 102 in that it fits within the short lower lobe of a single-deck BWB aircraft between skin panels 40' and floor decking (not shown) and is configured to absorb impact energy in the event of a crash or hard landing to reduce the impact energy conveyed to the main lobe of the aircraft. The energy absorbing flooring system 102' differs from the energy absorbing flooring system 102, however, in that each span of stub frames 106, floor beams, 118, and energy absorbing stanchions 116, is replaced by an integrated compressible energy absorbing member 200. In FIGS. 8 and 9, a single compressible energy absorbing member 200 is shown in cross section. But it is to be understood that a single-deck BWB aircraft with the energy absorbing flooring system 102' will comprise a plurality of compressible energy absorbing members extending spanwise at spaced apart locations along the longitudinal roll axis of the aircraft.

In the illustrated embodiment, each energy absorbing member 200 has an I-beam shape including a lower flange 201, an upper flange 202, and a web 203 extending vertically from the lower flange to the upper flange. The lower flange 201 of each energy absorbing member 200 is joined to the lower skin assembly 103' of the skin panels 40', specifically to the inner surface of the lower skin panels 40' that define the bottom aerodynamic surface of aircraft and the ribs 104' disposed thereon. The energy absorbing members 200 are configured to support seat tracks (not shown) and/or floor decking (not shown) on the upper flanges 202. For example, seat tracks can be affixed to the upper flanges 202 and support floor decking panels in a similar manner to how the seat tracks 120 and floor decking panels 150 mount on the floor beams 118 of the energy absorbing flooring system 102 above. Each energy absorbing member 200 has a height H3 corresponding to the internal height of the lower lobe of the aircraft. In the typical embodiment, the height H3 will be less than 24 inches. The web 203 has a front side 214 (left side in FIGS. 8 and 9), a back side 216 (right side in FIGS. 8 and 9), and a thickness T1 extending from the front side to the back side. In the illustrated embodiment, the thickness T1 tapers along the height H3 as the web 203 extends from the lower flange 201 to the upper flange 202.

In the illustrated embodiment, the front side 214 and the back side 216 of the web 203 are depicted as being flat. It will be understood, however, that in other embodiments, the sides of the energy absorbing member could have other shapes without departing from the scope of the disclosure.

Each compressible energy absorbing member 200 broadly comprises a compressible core 206 and a casing 208 surrounding the core. The core 206 occupies most of the thickness T1 of the web 203. The casing 208 forms the front and rear surfaces 214, 216 of the web 203 as well as the lower and upper flanges 201, 202. The core 206 suitably comprises a foam structure with negligible load bearing capacity. Alternatively, other shape-defining support materials can also be used for the core, e.g., pre-cured hollow shapes, honeycomb core, or a combination of any of the aforementioned materials. In the illustrated embodiment, the core 206 has a generally constant cross-sectional shape. In other embodiments, the core 206 could have a cross-sectional shape that varies along the span. For example, cores 206 having a sine-wave form or cores with discontinuities (e.g., embedded hollow forms) can also be used without departing from the scope of the disclosure.

In contrast with the core 206, the casing 208 comprises reinforced composite material, such as carbon fiber, that can carry substantial loads. For example, the composite material used for the casing 208 is preferably configured to carry the load of the aircraft floor and objects supported by the floor including seating, passengers, cargo, etc. The composite casing 208 is suitably formed as an overwrap on the core 206. The composite casing 206 is adhered to the core around the entire perimeter of the core.

Each compressible energy absorbing member 200 further comprises at least one restraint 210 affixing the casing 208 to the core 206 to define a plurality of crush zones 218 along which the compressible energy absorbing member is configured to collapse (see FIG. 9) to absorb impact energy. In the illustrated embodiment, each energy absorbing member 200 has three restraints 210 at spaced apart locations along the height H3 to define four crush zones 218 spaced apart along the height. Each restraint 210 comprises stitching 212 made of reinforcing fiber. The stitching runs 212 lengthwise (e.g., along the length of the energy absorbing member 200, which is spanwise in relation to the aircraft) and extends through the thickness T1 of the compressible energy absorbing member 200 from the front side 214 to the back side 216. In each of the crush zones 218, the compressible energy absorbing member 200 is free of stitching extending through the thickness T3 of the compressible energy absorbing member.

Each restraint 210 may be comprised of a single path of stitching 212 or of multiple stitching paths that are located in close proximity to one another. The number of paths of stitching 212 may vary among a plurality of restraints 210 spaced apart along the height H3 of the compressible energy absorbing member 200. The stitching 212 may extend the entire span of the compressible absorbing member 200 or have a length that is less than the entire span of the compressible absorbing member. In some embodiments, stitching 212 may extend along a closed path that forces a complete loop. For example, closed loop paths of stitching 212 may be provided around cutouts or other elements formed in the energy absorbing member 2100. The stitching 212 along each restraint 210 may run in a straight line along the span of the energy absorbing member 200 or run along a non-straight (e.g., zig-zag or sinusoidal) path.

The stitching 212 is formed from reinforcing fiber. For example, the stitching 212 may be comprised of nylon threads, carbon threads, glass threads, Kevlar threads, other common thread materials, or a combination thereof. The threads forming the stitching 212 may vary in thread thickness and material along the height of the compressible absorbing member 200. The characteristics of the restraints 210 may vary between the compressible absorbing members 200 in the energy absorbing flooring system 102'.

When an aircraft experiences an impact from a crash or hard landing, it imparts a compressive load on the compressible energy absorbing member 200, as indicated by the arrow in FIG. 9. Under a sufficient compressive load, the composite casing 208 will fail structurally and collapse. When this occurs, the casing 208 separates from the core 206, and the height H3 of the energy absorbing member 200 decreases as the energy absorbing member 200 collapses. Without the restraints 210, under sufficient impact loads, the casing 208 would separate from the core 206 and the energy absorbing member 200 would collapse all at once. As explained below, the restraints 210 provided localized crush zones 218 so that the casing 208 must separate from the core 206 in each individual crush zone to exhaust the energy absorbing capacity of the energy absorbing member 200. For example, the energy absorbing member 200 may be configured to progressively collapse within each of the localized crush zones 218 in stages, rather than all at once.

The stitching 212 provides structural reinforcement that restrains the casing 208 from separating from the core 206 at each restraint 210. By contrast, the casing 208 is comparatively free to separate from the core 206 along each crush zone 218. The effect of this is to isolate the structural failure and collapse of the energy absorbing member 200 to occur within each individual crush zone 218. Further, the restraints 210 enable multiple distinct moments of structural failure occur (at least one structural failure in each crush zone 218) rather than the energy absorbing member failing all at once. The inventor believes that this provides a more efficient energy absorbing structure that may absorb more impact energy within the same cross section. The energy absorbing member 200 may be configured so that the localized collapse of each crush zone 218 occurs in an incremental fashion, e.g., with the crush zones configured to fail consecutively from top to bottom or bottom to top. In certain embodiments, as shown in FIG. 9, the restraints 210 may cause the energy absorbing member 200 to collapse in an accordion fold. In certain embodiments, the stitching 212 may be configured to undergo tensile failures after the crush zones 218 have collapsed to provide additional energy absorption.

As can be seen, this disclosure provides two energy absorbing flooring systems 102, 102' that fit in a lower lobe of a single-deck BWB aircraft having a height of less than 24 inches. Despite the limited space available in the lower lobe of an aircraft of this type, both energy absorbing flooring systems 102, 102' are still able to absorb impact energy imparted on the single-deck BWB aircraft to reduce impact energy conveyed to the main lobe of the aircraft. Thus, the energy absorbing flooring systems 102, 102' increase the survivability and reduce damage during emergency landings.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant’s general inventive concept.

What is claimed is:

1. An energy absorbing flooring system for a single-deck blended wing-body (BWB) aircraft comprising:
a skin assembly comprising skin panels forming an aerodynamic surface along a bottom side of the BWB aircraft and a plurality of stub frames joined to the skin panels;
a plurality of floor beams spaced apart above the stub frames by a height of less than 24 inches;
floor decking supported on the floor beams; and
a plurality of energy absorbing stanchions, each energy absorbing stanchion comprising a lower end portion affixed to one of the stub frames and an upper end portion affixed to one of the floor beams, the energy absorbing stanchions configured to absorb energy from an impact on the BWB aircraft by deforming or structurally failing.

2. The energy absorbing flooring system of claim 1, wherein each energy absorbing stanchion has an inverted "Y" shape.

3. The energy absorbing flooring system of claim 2, wherein each energy absorbing stanchion includes an upper member defining the upper end portion and two lower members extending obliquely downward from the upper member, the two lower members defining the lower end portion of each energy absorbing stanchion.

4. The energy absorbing flooring system of claim 3, wherein each of the upper member and the two lower members has a C-shaped cross sectional shape.

5. The energy absorbing flooring system of claim 4, wherein each energy absorbing stanchion is configured to absorb energy by crippling and then bending out of plane.

6. The energy absorbing flooring system of claim 1, wherein the stub frames and the floor beams extend spanwise parallel to a lateral pitch axis of the BWB aircraft.

7. The energy absorbing flooring system of claim 6, wherein each floor beam is directly above one of the stub frames.

8. The energy absorbing flooring system of claim 1, further comprising seat tracks supported on the floor beams, the seat tracks oriented transverse to the floor beams.

9. The energy absorbing flooring system of claim 8, wherein the floor decking lies directly on the seat tracks.

10. The energy absorbing flooring system of claim 1, wherein the skin assembly further comprises a plurality of ribs joined to the skin panels and extending transverse to the stub frames.

11. The energy absorbing flooring system of claim 1, wherein the stanchions are load bearing components during normal use of the BWB aircraft.

12. A single-deck blended wing-body (BWB) aircraft comprising the energy absorbing flooring system of claim 1.

13. An energy absorbing flooring system for a single-deck blended wing-body (BWB) aircraft comprising:
skin panels forming an aerodynamic surface along a bottom side of the BWB aircraft; and
a plurality of compressible energy absorbing members joined to skin panels and configured for supporting floor decking in the single-deck BWB aircraft, wherein each compressible energy absorbing member comprises a core and a casing surrounding the core, each compressible energy absorbing member further comprising at least one restraint affixing the casing to the core to define a plurality of crush zones along which the compressible energy absorbing member is configured to collapse to absorb impact energy.

14. The energy absorbing flooring system as set forth in claim 13, wherein each restraint comprises stitching made of reinforcing fiber.

15. The energy absorbing flooring system as set forth in claim 14, wherein each compressible energy absorbing member has a front side, a back side, and a thickness extending from the front side to the back side and a length extending spanwise in relation to the BWB aircraft, wherein at each restraint, the stitching runs lengthwise and extends through the thickness of the compressible energy absorbing member from the front side to the back side.

16. The energy absorbing flooring system as set forth in claim 15, wherein the stitching restrains the casing from detaching from the core at each restraint, whereas the compressible energy absorbing member is comparatively free to detach from the core along each of the crush zones.

17. The energy absorbing flooring system as set forth in claim 15, wherein the compressible energy absorbing member is free of stitching extending through the thickness of the compressible energy absorbing member in each crush zone.

18. The energy absorbing flooring system as set forth in claim 14, wherein each casing is comprised of fiber-reinforced composite.

19. The energy absorbing flooring system as set forth in claim 14, wherein each core is a foam core.

20. A single-deck blended wing body (BWB) aircraft comprising:
a center body defining an interior volume including a main lobe and a lower lobe;
blended wings extending laterally outward from the center body; and
an energy absorbing flooring system including a floor deck separating the main lobe from the lower lobe, a skin panel assembly including skin panels defining a bottom aerodynamic surface of the single-deck BWB aircraft, and a plurality of energy absorbing members positioned between the skin panels and the floor deck, the energy absorbing members configured to absorb impact energy imparted on the single-deck BWB aircraft to reduce impact energy conveyed to the main lobe, wherein the lower lobe has a height extending from the skin panels to the floor deck and wherein the height of the lower lobe is less than 24 inches.
